(19) United States
(12) Patent Application Publication
(10) Pub. No.: US 2026/0158966 A1
(43) Pub. Date: Jun. 11, 2026

(54) VEHICLE BASE STRUCTURE

(71) Applicant: TOYOTA JIDOSHA KABUSHIKI KAISHA, Toyota-shi (JP)

(72) Inventor: Yosuke TORAZAWA, Toyota-shi (JP)

(73) Assignee: TOYOTA JIDOSHA KABUSHIKI KAISHA, Toyota-shi (JP)

(21) Appl. No.: 19/289,825

(22) Filed: Aug. 4, 2025

(30) Foreign Application Priority Data
Dec. 9, 2024 (JP) 2024-214668

(51) Int. Cl. B60L 58/27; B60L 53/16; H01M 10/615; H01M 10/625; H01M 10/6571; H01M 50/249; H01R 13/533

(52) U.S. Cl. CPC B60L 58/27; B60L 53/16; H01M 10/615; H01M 10/625; H01M 10/6571; H01M 50/249; H01R 13/533; H01M 2220/20; H01R 2201/26

(57) ABSTRACT

A vehicle base structure includes a power storage device that includes a case that houses a power storage module and that is installed in a lower portion of a vehicle, a connector portion that is provided in the case, and a heater element that raises temperature of the connector portion.

### CROSS-REFERENCE TO RELATED APPLICATION

This application claims priority to Japanese Patent Application No. 2024-214668 filed on Dec. 9, 2024. The disclosure of the above-identified application, including the specification, drawings, and claims, is incorporated by reference herein in its entirety.

### BACKGROUND

### 1. Technical Field

The present disclosure relates to a vehicle base structure.

### 2. Description of Related Art

Vehicles that are equipped with a power storage device that is charged with power from an external power source, and a heater that receives power from the external power source and warms the power storage device, have been conventionally known (e.g., see Japanese Unexamined Patent Application Publication No. 2016-051590 (JP 2016-051590 A)). In this vehicle, in a low-temperature environment, the power storage device is heated by the heater in order to quickly raise the temperature of the power storage device so as to become warm.

### SUMMARY

However, in a case in which a connector portion and an outer wall in the surroundings thereof in the power storage device have become iced-up (ice clumps have formed), and the iced-up state (ice clump) does not melt but breaks (cracks) due to vibrations of the vehicle, or the like, there is a risk of damage to the connector portion and a harness or the like that is connected to the connector portion.

Accordingly, an object of the present disclosure is to obtain a vehicle base structure that can suppress damage to the connector portion and the harness that is connected to the connector portion in low-temperature environments in which the connector portion and surroundings thereof may become iced-up.

In order to achieve the above object, a vehicle base structure according to a first aspect of the present disclosure includes a power storage device that includes a case that houses a power storage module and that is installed in a lower portion of a vehicle, a connector portion that is provided in the case, and a heater element that raises temperature of the connector portion.

According to the first aspect of the disclosure, the power storage device that is installed in the lower portion of the vehicle has the case that houses the power storage module. The case is provided with the connector portion. The connector portion is then heated by the heater element such that the temperature thereof is raised. Accordingly, even when the connector portion becomes iced-up in a low-temperature environment in which the connector portion and surroundings thereof may become iced up, the ice can be melted without being broken. Thus, damage to the connector portion and the harness connected to the connector portion is suppressed.

Also, with a second aspect of the vehicle base structure according to the present disclosure, in the vehicle base structure according to the first aspect, a cell heater for raising temperature of the power storage module is provided inside the case, and the heater element is electrically connected to the cell heater.

According to the second aspect of the disclosure, the cell heater for raising the temperature of the power storage module is provided inside the case, and the heater element is electrically connected to the cell heater. Accordingly, the connector portion can be heated with the heater element at the same timing as when the cell heater heats the power storage module. Thus, low-temperature startup capabilities, and safety of the vehicle, can be improved in a low-temperature environment in which the connector portion and the surroundings thereof may ice up.

Also, with a third aspect of the vehicle base structure according to the present disclosure, in the vehicle base structure according to the first or second aspects, the connector portion includes a connector block that is made of aluminum, disposed inside the case, and the heater element is provided to the connector block.

According to the third aspect of the disclosure, the connector portion has the connector block made of aluminum that is disposed inside the case, and the heater element is provided on the connector block. Now, the connector block is made of aluminum and accordingly has high thermal conductivity. Thus, even in a low-temperature environment in which the connector portion and the surroundings thereof may become iced-up, the connector portion is efficiently heated and the temperature is raised.

Also, with a fourth aspect of the vehicle base structure according to the present disclosure, in the vehicle base structure according to the first aspect, the connector portion includes a connector body that is disposed outside the case, and the heater element is provided to the connector body.

According to the fourth aspect of the disclosure, the connector portion has the connector body that is disposed outside the case, and the heater element is provided on the connector body. Accordingly, in a low-temperature environment in which the connector portion and the surroundings thereof may become iced-up, at least the iced-up portions on the connector body and the surroundings thereof can be melted without being broken.

Also, a vehicle base structure according to a fifth aspect of the present disclosure includes a power storage device that includes a case that houses a power storage module and that is installed in a lower portion of a vehicle, a connector portion that is provided at a vehicle front end portion of the case, an exhaust pipe that is disposed adjacently to an outer side of the case in a vehicle width direction, and a partition portion that is disposed between the connector portion and the exhaust pipe as viewed from a vehicle front-rear direction and is of a size to cover the connector portion as viewed from a vehicle width direction.

According to the fifth aspect of the disclosure, the power storage device that is installed in the lower portion of the vehicle has the case that houses the power storage module. The connector portion is provided at the vehicle front end of the case, and the exhaust pipe is disposed adjacently thereto on the outer side of the case in the vehicle width direction. The partition portion is disposed between the connector portion and the exhaust pipe as viewed from the vehicle front-rear direction, and the partition portion is formed with a size sufficient to cover the connector portion as viewed from the vehicle width direction.

Accordingly, in a low-temperature environment in which the connector portion and the surroundings thereof may become iced-up, the partition portion suppresses or prevents snow and ice that are kicked up by the wheels from reaching the connector portion. That is to say, icing-up of the connector portion and the outer wall in the surroundings thereof is suppressed or prevented. Thus, damage to the connector portion and the harness connected to the connector portion is suppressed.

As described above, according to the present disclosure, damage to the connector portion and the harness connected to the connector portion can be suppressed in a low-temperature environment in which the connector portion and the surroundings thereof may become iced-up.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic side view illustrating an iced-up state in a vehicle base structure according to a first embodiment;

FIG. 1B is a schematic side view illustrating a deiced state in the vehicle base structure according to the first embodiment;

FIG. 2A is a schematic side view illustrating a vehicle base structure according to a second embodiment;

FIG. 2B is a schematic front view illustrating the vehicle base structure according to the second embodiment;

FIG. 3A is a schematic side view illustrating a vehicle base structure according to a third embodiment;

FIG. 3B is a schematic front view illustrating the vehicle base structure according to the third embodiment;

FIG. 4A is a schematic side view illustrating a vehicle base structure according to a fourth embodiment;

FIG. 4B is a schematic front view illustrating the vehicle base structure according to the fourth embodiment;

FIG. 5A is a schematic side view illustrating a state of icing-up starting in a vehicle base structure according to a first comparative example;

FIG. 5B is a schematic side view illustrating an iced-up state in the vehicle base structure according to the first comparative example;

FIG. 5C is a schematic side view illustrating an ice-break damaged state in the vehicle base structure according to the first comparative example;

FIG. 6A is a schematic side view illustrating a vehicle base structure according to a second comparative example; and

FIG. 6B is a schematic front view illustrating the vehicle base structure according to the second comparative example.

### DETAILED DESCRIPTION OF EMBODIMENTS

Embodiments of the present disclosure will be described in detail below with reference to the drawings. For ease of description, arrows UP indicate an upward direction of a vehicle, arrows FR indicate a forward direction of the vehicle, and arrows RH indicates a rightward direction of the vehicle, in the drawings, as appropriate. Also, in the following description, directions such as up-down, front-rear, right-left refer to the up-down, front-rear, and right-left directions of the vehicle, unless otherwise specified. Also, the right-left direction is synonymous with a vehicle width direction.

### First Embodiment

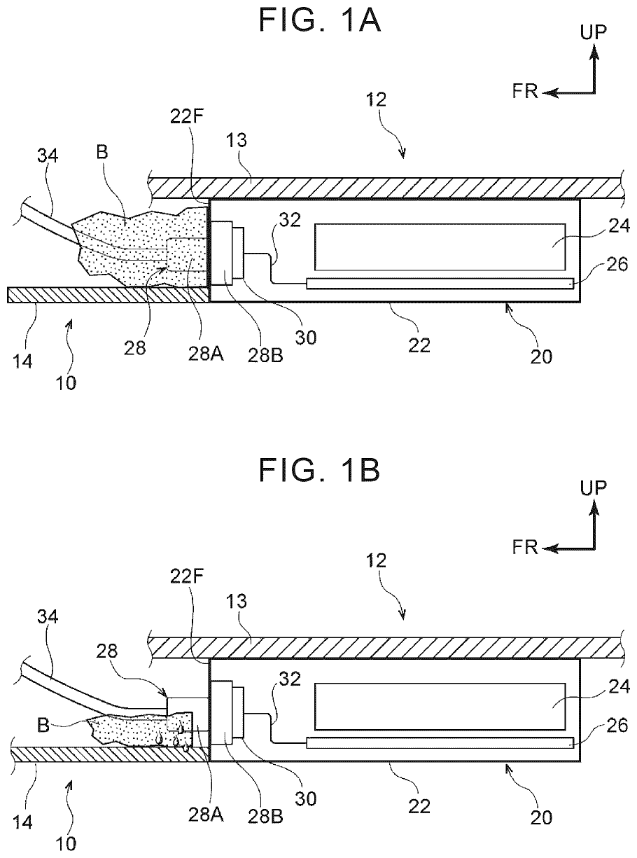

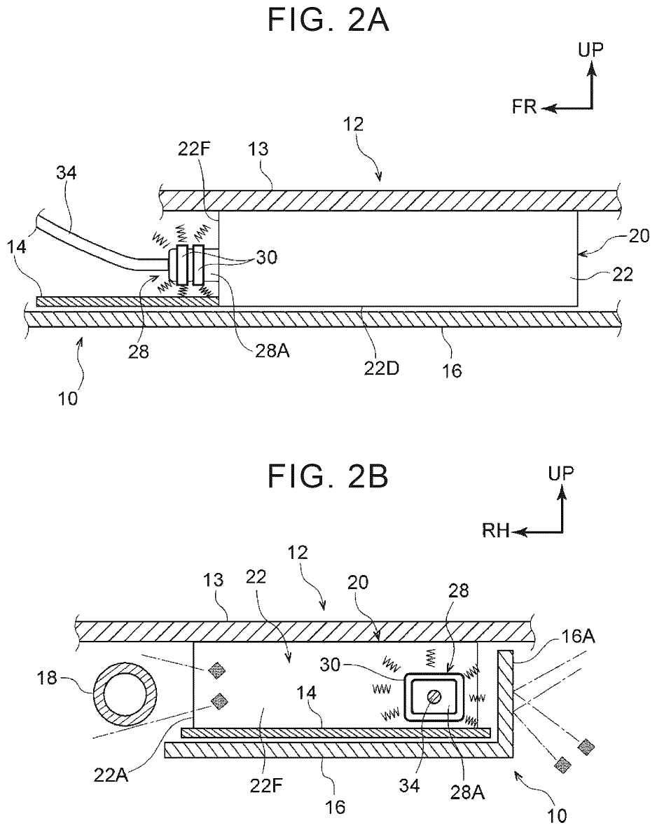

First, a first embodiment will be described. As illustrated in FIGS. 1A and 1B, a vehicle base structure 10 according to the first embodiment includes a power storage device 20 that is installed downward from a floor 13 of a vehicle 12. The vehicle 12 is, for example, a plug-in hybrid electric vehicle (PHEV). Accordingly, an exhaust pipe 18 (see FIG. 2B) is disposed adjacently to the rightward side (outer side in the vehicle width direction) of the power storage device 20, which will be described later.

The power storage device 20 has a case 22 that is made of metal in an approximately rectangular box shape, and a protective plate 14 in an approximately rectangular flat shape and extending forward is integrally provided with a predetermined thickness on a lower end portion of a front wall (outer wall at the front end portion) 22F of the case 22. The protective plate 14 protects a connector portion 28 and a harness 34 (described later) from interference with other objects and the like.

The case 22 houses a power storage module 24 therein. A cell heater 26 is provided below the power storage module 24 inside the case 22 to heat the power storage module 24 and raise the temperature thereof. The cell heater 26 is formed to be slightly larger than the power storage module 24 in plan view, such that the entire power storage module 24 can be heated.

Also, a connector portion 28 is provided on the left side of the front wall 22F of the case 22 (one side in vehicle width direction, opposite side from exhaust pipe 18). The connector portion 28 has a connector body 28A that is disposed outside the case 22 and a connector block 28B that is disposed inside the case 22. The connector block 28B is made of aluminum (aluminum alloy) by die casting.

A heater element 30 for heating the connector portion 28 to raise the temperature thereof is provided on a rear wall of the connector block 28B. This heater element 30 is electrically connected to the cell heater 26 by a wire 32 and is configured to operate (become energized) in conjunction with the cell heater 26 being operated (energized). Further, the harness 34 that is routed from the front side is connected to the connector body 28A.

Next, the operations of the vehicle base structure 10 according to the first embodiment that is configured as above will be described.

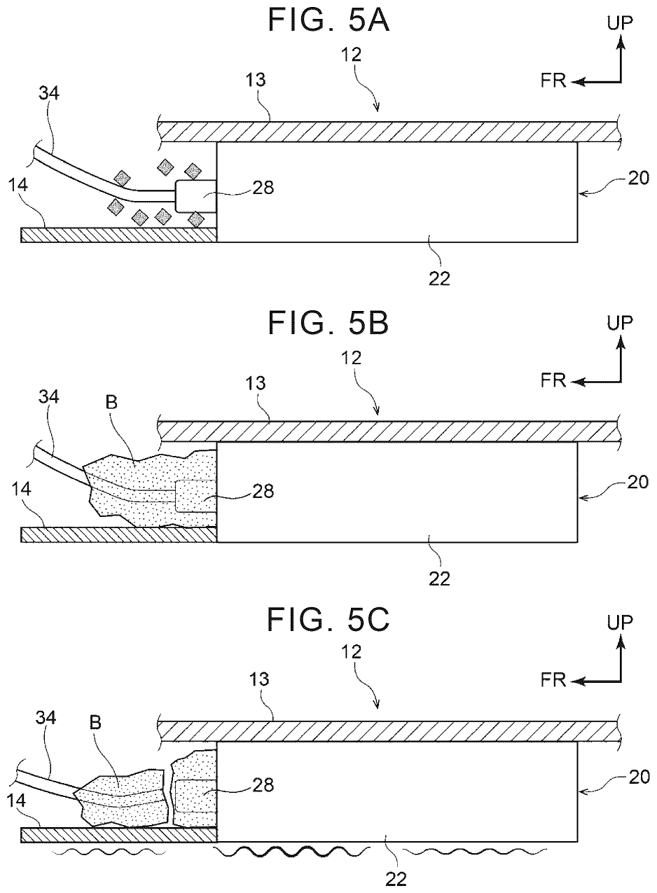

First, a vehicle base structure according to a first comparative example, illustrated in FIGS. 5A, 5B, and 5C, will be described. In this first comparative example, the heater element 30 is not provided. In the vehicle base structure, the forward side and also the rightward side of the power storage device 20 (case 22) cannot be completely covered with an exterior member or the like, since the exhaust pipe 18, which becomes hot, is disposed thereat. Accordingly, as illustrated in FIG. 5A, snow and ice that are kicked up by wheels (omitted from illustration) readily reaches the connector portion 28 (connector body 28A) from the exhaust pipe 18 side.

Note that, although omitted from illustration in FIGS. 1A, 1B, 5A, 5B, and 5C, on the front and left sides of the power storage device 20 (case 22), there is an upright wall portion 16A that is erected at a left end portion (one end portion in the vehicle width direction) of an undercover 16 that will be described later, and also at a portion forward from the front wall 22F of the case 22. Accordingly, a configuration is provided in which snow and ice that are kicked up by the wheels (omitted from illustration) do not readily reach the connector portion 28 (connector body 28A) from the side opposite the exhaust pipe 18.

When snow or ice reaches the connector portion 28 from the exhaust pipe 18 side, ice clumps B are readily formed on the connector portion 28 and the front wall 22F in the surroundings thereof, due to the accumulation and icing-up of the snow or ice, due to the protective plate 14 being disposed on the lower side of the connector portion 28, as illustrated in FIG. 5B. In this case, as illustrated in FIG. 5C, in a case in which the ice clump B breaks (cracks) without melting, due to vibrations of the vehicle 12, or the like, the connector portion 28 and the harness 34 that is connected to the connector portion 28 will be damaged along with the breaking of the ice clump B.

Accordingly, in the vehicle base structure 10 according to the first embodiment, the heater element 30 is provided in the connector block 28B of the connector portion 28. That is to say, the connector portion 28 is heated by the heater element 30 and the temperature is raised. Accordingly, in a low-temperature environment in which the connector portion 28 and the surroundings thereof may become iced-up, even when the connector portion 28 and the front wall 22F in the surroundings thereof are frozen (ice clump B is formed) as illustrated in FIG. 1A, the ice (ice clump B) can be melted without breaking, as illustrated in FIG. 1B.

Thus, in a low-temperature environment in which the connector portion 28 and the surroundings thereof may become iced-up, damage to the connector portion 28 and the harness 34 that is connected to the connector portion 28 can be suppressed or prevented. In particular, the connector block 28B made of aluminum (aluminum alloy) by die casting has high thermal conductivity, and accordingly can efficiently heat the connector portion 28 to raise the temperature thereof.

Also, the heater element 30 is electrically connected by the wire 32 to the cell heater 26 that raises the temperature of the power storage module 24. Accordingly, the heater element 30 can be operated in conjunction with the operation of the cell heater 26. That is to say, the connector portion 28 can be heated by the heater element 30 at the same timing as when the cell heater 26 heats the power storage module 24. Thus, low-temperature startup capabilities, and safety of the vehicle 12, can be improved in a low-temperature environment in which the connector portion 28 and the surroundings thereof may ice up.

Also, the heater element 30 can also be controlled simply by controlling the cell heater 26, and accordingly increase in manufacturing costs can be suppressed as compared to a configuration in which the heater element 30 is controlled separately. Also, the heater element 30 is provided inside the case 22, and accordingly there is no need to seal the heater element 30 separately, which also enables increase in manufacturing costs to be suppressed.

### Second Embodiment

Next, a second embodiment will be described. Note that the same reference numerals are used to denote the same parts as those in the first embodiment, and detailed description thereof will be omitted as appropriate.

As illustrated in FIGS. 2A and 2B, the vehicle base structure 10 according to this second embodiment differs from the first embodiment only in that the heater element 30 is provided on the connector body 28A rather than in the connector block 28B of the connector portion 28. That is to say, the connector body 28A is formed in a substantially square tube shape, and the heater element 30 is attached in an annular form to an outer peripheral portion of the connector body 28A. Note that while two heater elements 30 are illustrated provided at the front and rear, a configuration may be made in which just one is provided, or a configuration may be made in which three or more are provided.

Also, as illustrated in FIG. 2B, the exhaust pipe 18, through which exhaust gas from an engine (omitted from illustration) that is housed in an engine compartment passes, is disposed adjacently to the right side of the case 22 (outer side in the vehicle width direction). That is to say, the exhaust pipe 18 is disposed substantially along a peripheral wall 22A of the case 22, and extends rearward. Accordingly, the connector portion 28 is disposed on the left side of the case 22 (the side opposite the exhaust pipe 18) , such that the harness 34 does not come into contact with the exhaust pipe 18.

Further, the undercover 16 that covers a lower portion of the vehicle 12 is disposed below the power storage device 20 (case 22). The undercover 16 is disposed in a state of having a predetermined gap as to an entire lower face of a lower wall 22D of the case 22 in the up-down direction, including the protective plate 14. Also, as illustrated in FIG. 2B, the upright wall portion 16A is integrally erected at the left end portion (one end portion in the vehicle width direction) of the undercover 16 and also in the portion forward of the front wall 22F of the case 22.

The upright wall portion 16A is formed with a size sufficient to cover the connector portion 28 (connector body 28A including heater element 30) as viewed in the vehicle width direction. Accordingly, this upright wall portion 16A is configured to suppress or prevent snow and ice that are kicked up by the wheels (omitted from illustration) from reaching the connector body 28A of the connector portion 28 from the side opposite the exhaust pipe 18. Note that the upright wall portion 16A is omitted from illustration in FIG. 2A.

Next, operations of the vehicle base structure 10 according to the second embodiment that is configured as described above will be described. Note that description of operations common to the first embodiment will be omitted as appropriate.

In the vehicle base structure 10 according to the second embodiment, the heater element 30 is provided in the connector body 28A of the connector portion 28. That is to say, the connector body 28A of the connector portion 28 is heated by the heater element 30 and the temperature is raised. Therefore, in a low-temperature environment in which the connector portion 28 and the surroundings thereof may become iced-up, at least the iced-up portion (ice clumps) on the connector body 28A and the surroundings thereof can be melted without breaking the ice.

Thus, in a low-temperature environment in which the connector portion 28 and the surroundings thereof may become iced-up, damage to the connector portion 28 and the harness 34 that is connected to the connector portion 28 can be suppressed or prevented. Note that the upright wall portion 16A provided on the undercover 16 suppresses or prevents snow and ice from reaching the connector body 28A of the connector portion 28 from the side opposite the exhaust pipe 18. This reduces the possibility that the connector portion 28 and the surroundings thereof will become iced-up. This also applies to the first embodiment.

Also, in the second embodiment, a configuration may be made in which the heater element 30 is operated at a timing that is separate from that of the cell heater 26. That is to say, the heater element 30 may be configured to operate regardless of the operation time of the cell heater 26. In this case, however, it is preferable to provide a determination device or the like that determines whether icing-up (ice clumps) has occurred, and whether the iced-up portion (ice clumps) has melted and disappeared, at the connector portion 28 and the surroundings thereof.

### Third Embodiment

Next, a third embodiment will be described. Note that the same reference numerals are used to denote the same parts as those in the first embodiment and the second embodiment, and detailed description thereof will be omitted as appropriate.

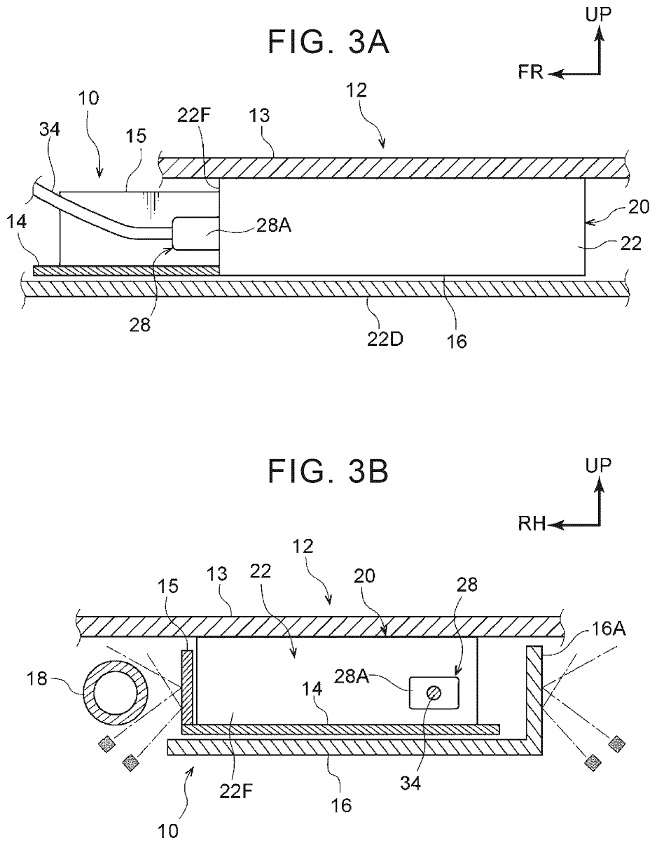

As illustrated in FIGS. 3A and 3B, the vehicle base structure 10 according to this third embodiment differs from the first and second embodiments only in that the heater element 30 is not provided, and instead, a partition portion 15 that is substantially rectangular and flat, is integrally erected with a predetermined thickness on the right end portion (other end portion in vehicle width direction) of the protective plate 14.

As illustrated in FIG. 3B, the partition portion 15 is disposed between the connector portion 28 (connector body 28A) and the exhaust pipe 18 as viewed from the front-rear direction, and as illustrated in FIG. 3A, is formed with a size sufficient to cover the connector portion 28 (connector body 28A) as viewed from the vehicle width direction. Note that the upright wall portion 16A is omitted from illustration in FIG. 3A.

Next, operations of the vehicle base structure 10 according to the third embodiment that is configured as described above will be described. It should be noted that description of operations common to the first and second embodiments will be omitted as appropriate.

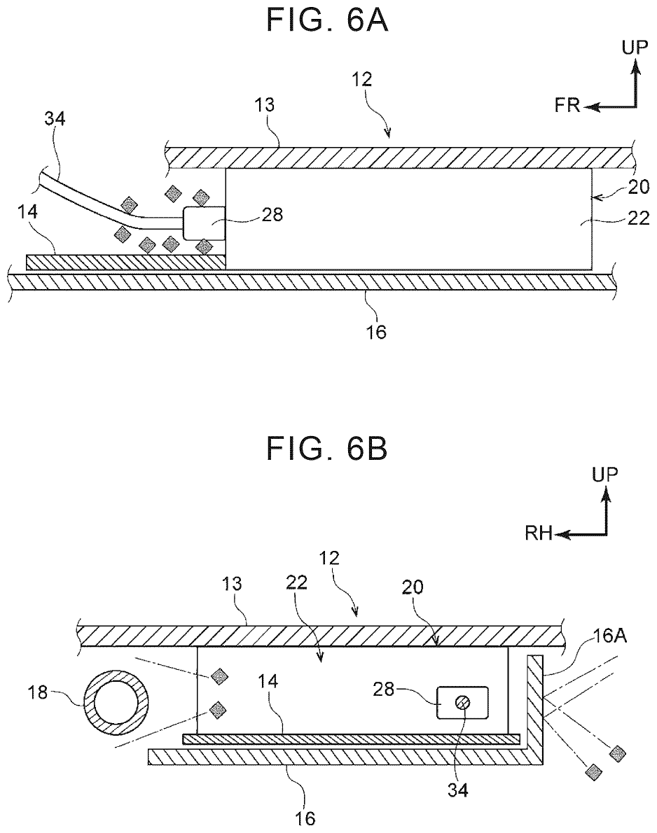

First, a vehicle base structure according to a second comparative example, illustrated in FIG. 6A, and 6B, will be described. In this second comparative example, the partition portion 15 is not provided. Accordingly, as illustrated in FIGS. 6A and 6B, snow and ice reach the connector portion 28 (connector body 28A) from the exhaust pipe 18 side, and the connector portion 28 and the front wall 22F in the surroundings thereof will become iced-up. In this case, when the iced-up portion (ice clump) breaks without melting, the connector portion 28 and the harness 34 connected to the connector portion 28 will be damaged along with the breakage of the ice clump.

Accordingly, in the vehicle base structure 10 according to the third embodiment, the partition portion 15 is integrally erected on the right end portion (other end portion in vehicle width direction) of the protective plate 14. Thus, as illustrated in FIG. 3B, the partition portion 15 can suppress or prevent snow and ice from reaching the connector portion 28 (connector body 28A) from the exhaust pipe 18 side. That is to say, the connector portion 28 and the front wall 22F in the surroundings thereof can be suppressed or prevented from becoming iced-up.

Thus, in a low-temperature environment in which the connector portion 28 and the surroundings thereof may become iced-up, damage to the connector portion 28 and the harness 34 that is connected to the connector portion 28 can be suppressed or prevented. Moreover, this partition portion 15 is erected on the protective plate 14 that is provided at the front end portion of the case 22. Accordingly, providing of the partition portion 15 can be easily realized.

### Fourth Embodiment

Finally, a fourth embodiment will be described. Note that the same reference numerals are used to denote the same parts as those in the first embodiment through the third embodiment, and detailed description thereof will be omitted as appropriate.

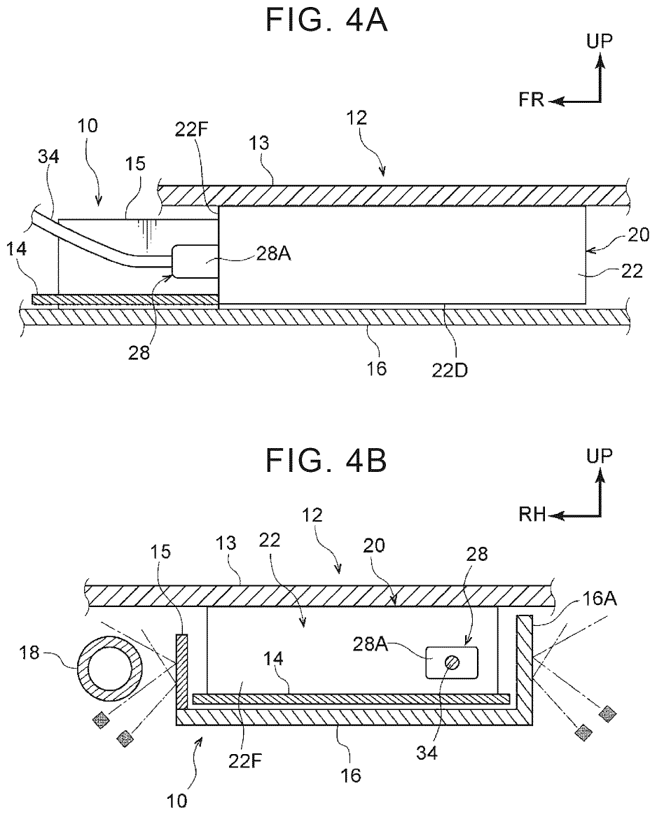

As illustrated in FIGS. 4A and 4B, the vehicle base structure 10 relating to this fourth embodiment differs from the above third embodiment only in that the partition portion 15 is integrally erected on the right end portion (other end portion in vehicle width direction) of the undercover 16, rather than on the right end portion (other end portion in vehicle width direction) of the protective plate 14.

As illustrated in FIG. 4B, the partition portion 15 is disposed between the connector portion 28 (connector body 28A) and the exhaust pipe 18 as viewed from the front-to-rear direction, and as illustrated in FIG. 4A, is formed with a size sufficient to cover the connector portion 28 (connector body 28A) as viewed from the vehicle width direction. Note that the upright wall portion 16A is omitted from illustration in FIG. 4A.

Next, operations of the vehicle base structure 10 according to the fourth embodiment that is configured as described above will be described. It should be noted that description of operations common to the first embodiment to the third embodiment will be omitted as appropriate.

In the vehicle base structure 10 according to this fourth embodiment, the partition portion 15 is integrally erected on the right end portion (other end portion in vehicle width direction) of the undercover 16. Thus, as illustrated in FIG. 4B, this partition portion 15 can suppress or prevent snow and ice from reaching the connector portion 28 (connector body 28A) from the exhaust pipe 18 side. That is to say, the connector portion 28 and the front wall 22F in the surroundings thereof can be suppressed or prevented from becoming iced-up.

Thus, in a low-temperature environment in which the connector portion 28 and the surroundings thereof may become iced-up, damage to the connector portion 28 and the harness 34 that is connected to the connector portion 28 can be suppressed or prevented. Moreover, this partition portion 15 is provided upright on the undercover 16 that covers the lower portion of the vehicle 12. Accordingly, providing of the partition portion 15 can be easily realized.

While the vehicle base structure 10 according to the present embodiment has been described above based on the drawings, the vehicle base structure 10 according to the present embodiment is not limited to that illustrated in the drawings, and design changes can be made as appropriate without departing from the gist of the present disclosure. For example, the connector portion 28 is not limited to the configuration in which only one is provided as illustrated in the drawings, but may be configured to have a plurality of connector portions that is arrayed in the vehicle width direction.

When a plurality of the connector portions 28 are provided, the heater element 30 in the first and second embodiments is provided for each of the connector portions 28. Also, in the first embodiment, a configuration may be made in which the heater element 30 is operated at a timing that is separate from that of the cell heater 26. Also, the third embodiment or the fourth embodiment may be applied to the first embodiment, and the third embodiment or the fourth embodiment may be applied to the second embodiment.

What is claimed is:

1. A vehicle base structure, comprising:
a power storage device that includes a case that houses a power storage module and that is installed in a lower portion of a vehicle;
a connector portion that is provided in the case; and
a heater element that raises temperature of the connector portion.

2. The vehicle base structure according to claim 1, wherein
a cell heater for raising temperature of the power storage module is provided inside the case, and
the heater element is electrically connected to the cell heater.

3. The vehicle base structure according to claim 1, wherein
the connector portion includes a connector block that is made of aluminum, disposed inside the case, and
the heater element is provided to the connector block.

4. The vehicle base structure according to claim 1, wherein
the connector portion includes a connector body that is disposed outside the case, and
the heater element is provided to the connector body.

5. A vehicle base structure, comprising:
a power storage device that includes a case that houses a power storage module and that is installed in a lower portion of a vehicle;
a connector portion that is provided at a vehicle front end portion of the case;
an exhaust pipe that is disposed adjacently to an outer side of the case in a vehicle width direction; and
a partition portion that is disposed between the connector portion and the exhaust pipe as viewed from a vehicle front-rear direction and is of a size to cover the connector portion as viewed from a vehicle width direction.
